(19) United States
(12) Patent Application Publication
(10) Pub. No.: US 2016/0084422 A1
(43) Pub. Date: Mar. 24, 2016

(54) HOSE COUPLING

(71) Applicant: EAGLELITE INDUSTRIAL CO., LTD., Chiao-Hsi (TW)

(72) Inventor: Shen-Chih Lee, New Taipei City (TW)

(21) Appl. No.: 14/836,941

(22) Filed: Aug. 26, 2015

(30) Foreign Application Priority Data
Sep. 22, 2014 (CN) 201420547396.7

(51) Int. Cl. F16L 55/115

(52) U.S. Cl. CPC F16L 55/1157

(57) ABSTRACT

A hose coupling includes a hose coupling member and a cover. The hose coupling member is provided with an annular groove. A grip is provided on top of the cover. The cover is provided with two handles on two opposing sides of the cover. The cover is formed with through holes corresponding to the handles. One end of each handle is a curved limit portion and hinged on the cover. The curved limit portion passes through the corresponding through hole to engage with the annular groove. The seat is formed with a first pin hole for a safety pin to be inserted therethrough. Through the grip, the fluid hose can be dragged conveniently. The connecting structure of the hose coupling member and the cover is more stable, such that the cover can better protect the distal end of the fluid hose to prevent the cover from loosening.

### BACKGROUND OF THE INVENTION

(a) Field of the Invention

The present invention relates to a hose coupling, and more particularly to a hose coupling for sealing the distal end of a fluid hose.

(b) Description of the Prior Art

A hose coupling is used to connect the piping of a fluid transport system with a hydraulic component or to seal the distal end of the piping. The hose coupling is the general term of a connecting part which can be disassembled and assembled for a fluid passage. An existing hose coupling used to seal the distal end of a fluid hose (for example: a water hose) includes a hose coupling member connected with a fluid hose and a cap to cover the port of the hose coupling member. The hose coupling member and the cap are connected by a locking device and locked through a safety pin so as to seal the distal end of the fluid hose. In general, the hose coupling is provided with a hook loop. When the hose coupling is connected with the fluid hose, the fluid hose can be dragged by means of the user's finger to hook the hook loop. If the fluid hose is longer, it is laborious to drag the hose by the hook loop and the hook loop may break. During use, the distal end of the fluid hose may be damaged by collision. This causes not only economic loss but also a leakage of the fluid of the fluid hose. Accordingly, the inventor of the present invention has devoted himself based on his many years of practical experiences to solve this problem.

### SUMMARY OF THE INVENTION

The primary object of the present invention is to provide a hose coupling which is convenient and safe to use.

In order to achieve the aforesaid object, the hose coupling of the present invention comprises a hose coupling member and a cover. One end of the hose coupling member is for connecting with a distal end of a fluid hose. The cover is fitted on another end of the hose coupling member to seal the hose coupling member. A grip is provided on top of the cover. A space is defined between the grip and a top face of the cover for an operator's hand to pass therethrough. An upper end of the hose coupling member is provided with an annular groove around an outer circumferential wall thereof. The cover is provided with at least two handles on two opposing sides of the cover. The cover is further formed with through holes corresponding to the handles. The through holes face the annular groove. One end of each handle is a curved limit portion to mate with the annular groove. The curved limit portion is inserted into a corresponding one of the through holes to engage with the annular groove and hinged on the cover through a pivot seat. The seat comprises a first seat and a second seat oppositely disposed relative to the corresponding through hole. The curved limit portion is clamped between the first seat and the second seat. Outer ends of the first seat and the second seat are each formed with a first pin hole for a safety pin to be inserted therethrough, enabling the safety pin to lean against the curved limit portion.

In order to better position the handles and to prevent their turning from influencing the connection between the hose coupling member and the cover, another end of each handle is pressed against a limit member. The limit member is embedded on the grip corresponding in position to the corresponding handle. The limit member is retractable relative to the grip by applying a force.

Preferably, the joint of the grip and the top face of the cover is provided with a pair of lugs extending inward. Each lug is provided with a second pin hole for the safety pin to be hanged thereon, which is convenient for packing and transportation of the products and prevents the safety pin from getting lost.

Compared to the prior art, the advantage of the present invention is that the grip is provided and the space is defined between the grip portion and the top face of the cover for the operator's hand to pass therethrough. During use, the fluid hose coupled with the hose coupling member can be dragged conveniently by means of holding the grip. Through the curved limit portion to engage with the annular groove, the cover and hose coupling member are connected. Through the safety pin, the handle is locked. The limit member is provided to hold against the handle. The interior connecting structure of the hose coupling is more stable and the cover can better protect the distal end of the fluid hose so as to prevent the interior connection of the hose coupling from loosening and to prevent the distal end of the fluid hose from being damaged. The hose coupling can be dismantled and used conveniently.

### BRIEF DESCRIPTION OF THE DRAWINGS

FIG. 1 is a schematic view of a hose coupling according to a preferred embodiment of the present invention when connected to a fluid hose;

FIG. 2 is a perspective view of the hose coupling according to the preferred embodiment of the present invention;

FIG. 3 is an exploded view of the hose coupling according to the preferred embodiment of the present invention;

FIG. 4 is a schematic view showing the cover of the hose coupling according to the preferred embodiment of the present invention; and

FIG. 5 is an exploded view of the hose coupling showing the cover according to the preferred embodiment of the present invention.

### DETAILED DESCRIPTION OF THE PREFERRED EMBODIMENTS

Embodiments of the present invention will now be described, by way of example only, with reference to the accompanying drawings.

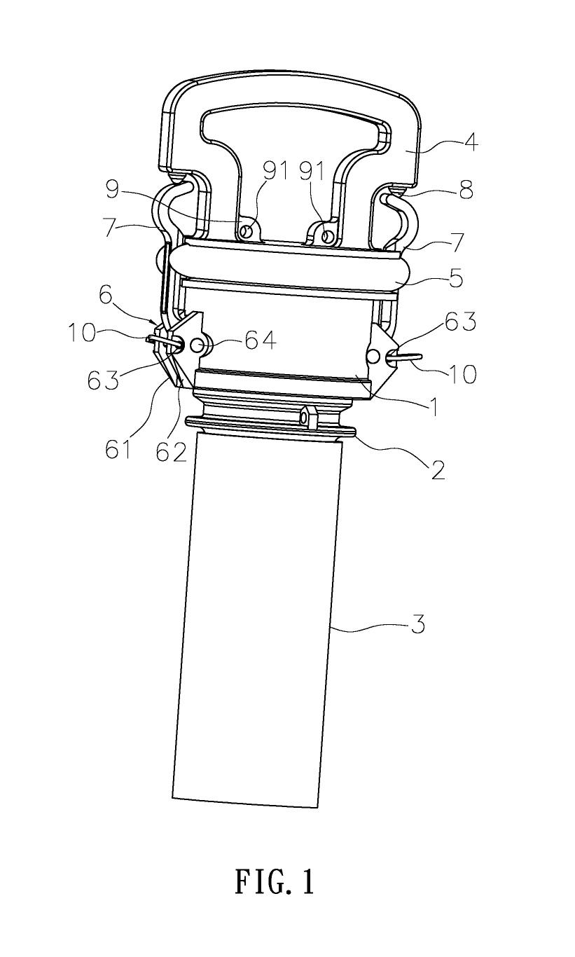

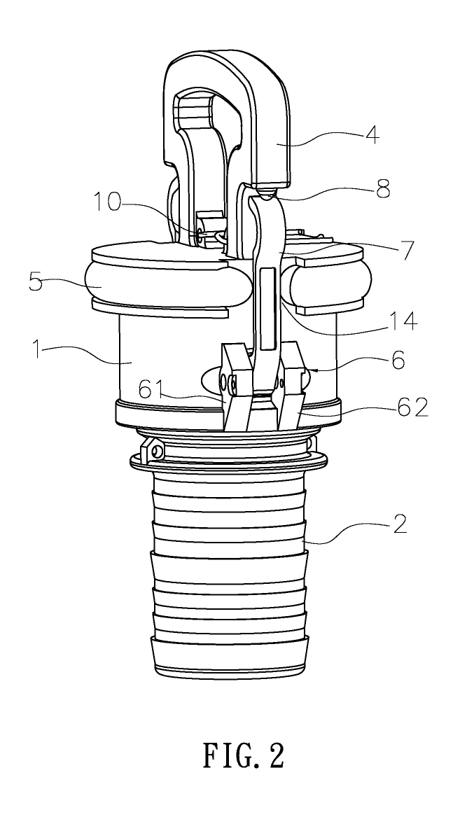

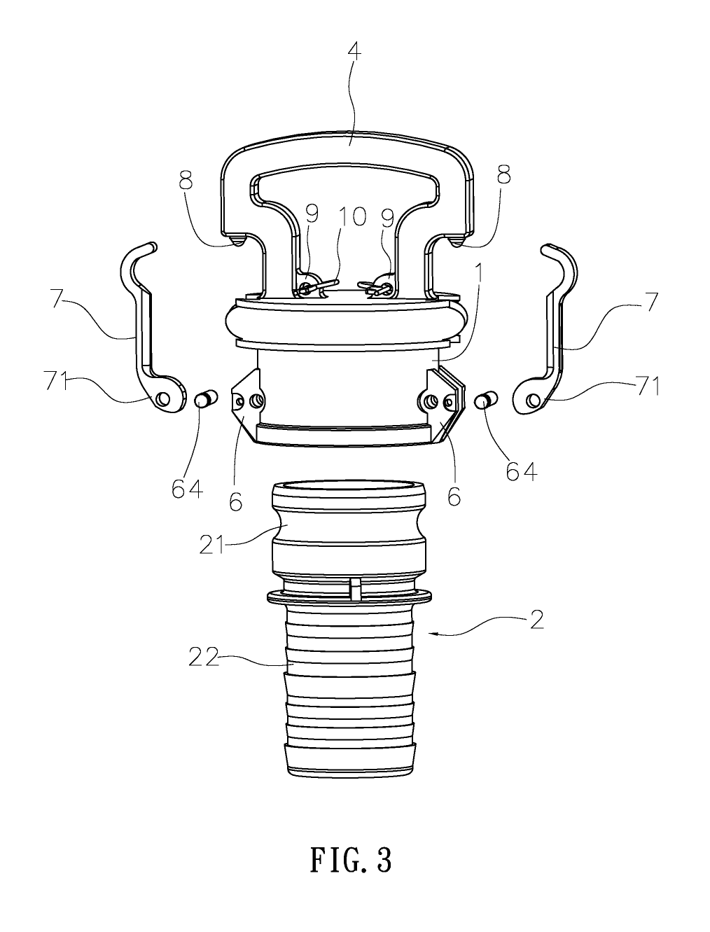

As shown in FIG. 1 and FIG. 2, a hose coupling according to a preferred embodiment of the present invention comprises a hose coupling member 2 and a cover 1. An upper end of the hose coupling member 2 is provided with an annular groove 21 around an outer circumferential wall thereof, as shown in FIG. 3. A lower end of the hose coupling member 2 is a threaded pipe 22. Through the threaded pipe 22, the hose coupling member 2 may be connected with a distal end of a fluid hose 3 (such as a soft water pipe). The cover 1 is disposed at the upper end of the hose coupling member 2 and configured to seal the hose coupling member 2. An arcuate grip 4 is provided on top of the cover 1. A space is defined between the grip 4 and a top face of the cover 1 for the operator's hand to pass therethrough. In this embodiment, the top face of the cover 1 has a circle shape. For a stable connection of the grip 4 and the cover 1 and for the operator to drag the fluid hose 3 by means of the grip, the grip 4 and the cover 1 are one-piece and the width of the grip is equal or greater than that the diameter of the top face of the cover 1. In this embodiment, the cover 1 is adapted to seal the hose coupling member 2 and to seal the distal end of the fluid hose 3, and it can protect the distal end of the fluid hose 3 from being impacted and damaged. The cover 1 has an annular flange 5 extending outward from the top face. The annular flange 5 is a flange wrapped with a rubber layer to protect the hose coupling member 2 from being impacted and to prevent the hose coupling member 2 from wear and tear.

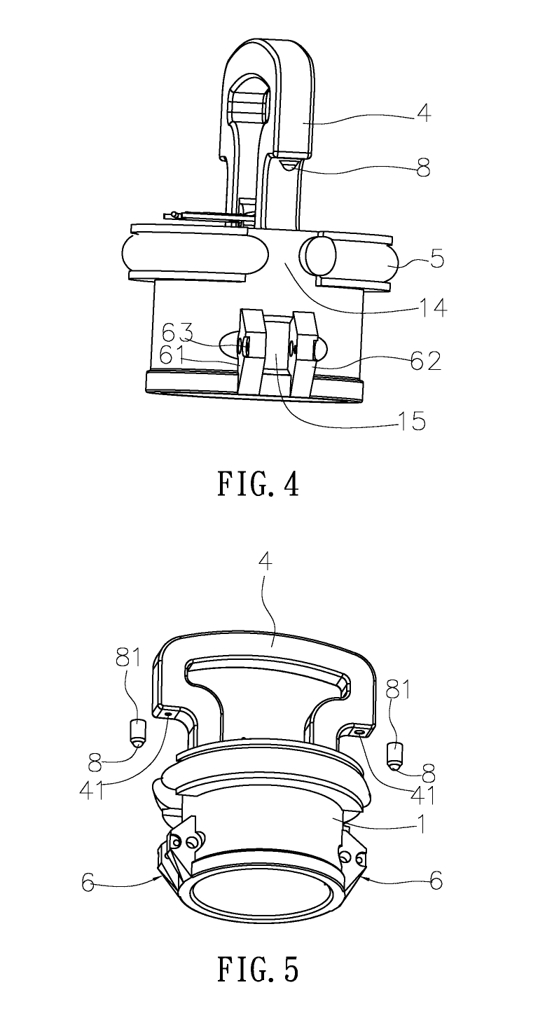

As shown in FIG. 3 and FIG. 4, the cover 1 is provided with two handles 7 on two opposing sides thereof. The cover 1 is further formed with through holes 15 corresponding to the handles 7. When the cover 1 and the hose coupling member 2 are mated, the through holes 15 face the annular groove 21. One end of each handle 7 is a curved limit portion 71 to mate with the annular groove 21. The curved limit portion 71 is inserted into a corresponding one of the through holes 15 to engage with the annular groove 21, such that the cover 1 and the hose coupling member 2 are connected together.

As shown in FIG. 2 and FIG. 3, through the limit portion 71, each handle 7 is hinged on the cover 1. Specifically, the limit portion 71 is hinged on the cover 1 through a pivot seat 6. The pivot seat 6 comprises a first seat 61 and a second seat 62 which are oppositely disposed relative to the corresponding through hole 15. The limit portion 71 is clamped between the first seat 61 and the second seat 62, and is pivotally connected between the first seat 61 and the second seat 62 by a shaft 64.

As shown in FIG. 3 and FIG. 5, in order to better position the handles 7 and to prevent its turning from influencing the connection between the hose coupling member 2 and the cover 1 during use, another end of each handle 7 is pressed against a limit member 8. The limit member 8 is embedded on the grip 4 corresponding in position to each handle 7. The limit member 8 is retractable relative to the grip 4 by applying a force. In this embodiment, the limit member 8 is a circular ball. Left and right sides of the grip 4 are bent inwardly to form bent portions, respectively. The limit member 8 is disposed on the bent portion and located opposite the pivot seat 6. Specifically, the grip 4 is formed with an installation hole 41. The circular ball is embedded in a cylindrical installation seat 81. Through the installation seat 81, the circular ball is mounted to the installation hole 41.

As shown in FIG. 2 and FIG. 4, for the handle 7 to be attached to the cover 1 tightly, the annular flange 5 is concaved to form a passage 14 corresponding in position to the pivot seat 6 for the handle 7 to pass therethrough.

As shown in FIG. 1 and FIG. 3, the first seat 61 and the second seat 62 are each provided with a first pin hole 63 corresponding in position to the shaft 64 for insertion of a safety pin 10. When the limit portion 71 of the handle 7 is engaged in the annular groove 21 of the hose coupling member 2, the safety pine 10 is adapted to limit the handle 7 and to prevent the limit portion 71 of the handle 7 from disengaging from the annular groove 21. When in use, the safety pin 10 is inserted into the pin hole 63 to hold against the curved limit portion 71 so as to prevent it from turning. The joint of the top face of the cover 1 and the grip 4 is provided with a pair of lugs 9 extending inward. Each lug 9 is provided with a second pin hole 91 for the safety pin 10 to be hanged thereon. When not in use, the safety pin 10 can be hanged on the second pin hole 91 to prevent the safety pin 7 from getting lost. When in use, it can be taken from the second pin hole 91 conveniently.

When the hose coupling of the present invention is used, as shown in FIG. 1, the threaded section 22 of the hose coupling member 2 is first inserted into the fluid hose 3 (such as, a soft water hose), so that the hose coupling member 2 and the fluid hose 3 are connected. After that, the cover 1 is fitted on the other end of the hose coupling member 2, and the through hole 15 is aligned with the annular groove 21. Each handle 7 is pulled upward, enabling the limit portion 71 to be engaged into the limit groove 21. The other end of each handle 7 is to lean against the limit member 8. The safety pin 10 is taken from the second pin hole 91 of each lug 9 to be inserted into the first pin hole 63. Through the safety pin 10, each handle 7 is locked, such that the installation of the hose coupling and the fluid hose 3 is completed. During use, the fluid hose 3 can be dragged conveniently by holding the grip 4.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hose coupling, comprising a hose coupling member and a cover, one end of the hose coupling member being disposed for connecting with a distal end of a fluid hose, the cover being fitted on another end of the hose coupling member to seal the hose coupling member;
a grip being provided on top of the cover, a space being defined between the grip and a top face of the cover for an operator's hand to pass therethrough;
an upper end of the hose coupling member being provided with an annular groove around an outer circumferential wall thereof, the cover being provided with at least two handles on two opposing sides of the cover, the cover being further formed with through holes corresponding to the handles, the through holes facing the annular groove, one end of each handle being a curved limit portion to mate with the annular groove, the curved limit portion being hinged on the cover through a pivot seat and inserted into a corresponding one of the through holes to engage with the annular groove;
the pivot seat comprising a first seat and a second seat oppositely disposed relative to the corresponding through hole, the curved limit portion being clamped between the first seat and the second seat, outer ends of the first seat and the second seat being each formed with a first pin hole for a safety pin to be inserted therethrough, enabling the safety pin to lean against the curved limit portion.

2. The hose coupling as claimed in claim 1, wherein another end of each handle is pressed against a limit member, the limit member is embedded on the grip corresponding in position to each handle, and the limit member is retractable relative to the grip by applying a force.

3. The hose coupling as claimed in claim 2, wherein the grip has an arc shape and a width is equal or greater than that of the top face of the cover, left and right sides of the grip are bent inwardly to form bent portions respectively, and the limit member is disposed on each bent portion and located opposite the seat.

4. The hose coupling as claimed in claim 2, wherein a joint of the top face of the cover and the grip is provided with a pair of lugs extending inward, and each lug is formed with a second pin hole for the safety pin to be hanged thereon.

5. The hose coupling as claimed in claim 3, wherein the cover has an annular flange extending outward from the top face of the cover, and the annular flange is a flange wrapped with a rubber layer and concaved to form a passage corresponding in position to the pivot seat for a corresponding one of the handles to pass therethrough.

6. The hose coupling as claimed in claim 2, wherein the limit member is a circular ball, the circular ball is embedded in an installation seat and mounted to the grip through the installation seat.

7. The hose coupling as claimed in claim 4, wherein the top face of the cover is wrapped with a rubber layer.

8. The hose coupling as claimed in claim 4, wherein the grip and the cover are one-piece.
